(19) United States
(12) Patent Application Publication
(10) Pub. No.: US 2008/0004124 A1
(43) Pub. Date: Jan. 3, 2008

(54) Apparatus for Simulating Glowing in a Solid Fuel Effect Fire

(76) Inventor: Noel O'Neill, County Louth (IE)

Correspondence Address: TROUTMAN SANDERS LLP, 600 PEACHTREE STREET , NE, ATLANTA, GA, 30308, US

(21) Appl. No.: 11/575,050

(22) PCT Filed: Sep. 12, 2005
(86) PCT No.: PCT/EP05/09776

§ 371 Date: Mar. 9, 2007

(30) Foreign Application Priority Data
Sep. 10, 2004 (GB) 0420104.2

(51) Int. Cl. F21S 10/04; A63G 31/00

(52) U.S. Cl. 472/65; 392/348; 40/428

(57) ABSTRACT

The present invention relates to apparatus for producing an optical effect and more especially to apparatus for simulating burning solid fuel, in particular in a fuel and/or flame effect electric fire. A simulated fuel element comprises two parts. First ends of optic fibres are located between the mating faces of these two parts. A light source radiates light into the second ends of the optic fibres at a location which is not visible to a user. The light is transferred thorough the optic fibres to the outer surface of the solid fuel element, thus providing the effect of glowing fuel.

The present invention relates to apparatus for producing an optical effect and more especially to apparatus for simulating burning solid fuel, in particular in a fuel and/or flame effect electric fire.

Fuel and flame effect fires are well known in the art and examples are described in GB 2 230 335 and EP 0 897 514. Typically, the simulated fuel bed of such a fire will comprise either a plastic moulding which is shaped and coloured to simulate a bed of embers and pieces of solid fuel or a plastic moulding shaped and coloured to resemble an ember bed and discrete pieces of simulated solid fuel disposed on the plastic moulding. In both cases, the fuel bed is illuminated from below with the intention of giving the impression of a burning, glowing fire. To enhance the effect of burning fuel, components of the fuel bed may be provided with reflective materials which provide point reflections of incident light. This is intended to give the effect of the changing intensity of light emitted by the burning fuel and to this end, the intensity of incident light on the fuel may be varied. Many means have been described in the art for varying the intensity of light incident on the fuel bed.

The prior has achieved simulated fuel beds which provide a very good impression of a real fuel bed. However, there remains room for improvement.

The logs employed in the present invention are provided with means for simulating the glowing or sparking of localised points on the log, as occurs with a real solid fuel fire. More specifically, the logs of the invention make use of optic fibres to provide this effect. The use of optic fibres in simulated domestic fires is, as such, already known. GB 2 256 040 teaches a fire which use a single-piece thermoplastic moulded fuel bed shaped and coloured to resemble logs and provided with a fibre optic based light source. The fibre optics terminate at points on the inner surface of the moulded fuel bed. While this arrangement may contribute to the general glow of the fuel bed it is ineffective in providing the point light sources simulating sparks and localised glow which the present invention seeks to achieve. In this respect, it is noted that the moulded thermoplastic fuel bed tends to be diffusing of light. The present invention takes a different approach in that the ends of the fibre optics are exposed at outer surfaces of the logs and are directly visible by a user.

According to a first aspect of the present invention there is provided a simulated solid fuel arrangement for a simulated solid fuel fire comprising
a light source
at least one simulated solid fuel element, the solid fuel element comprising conjoined first and second parts defining together the external shape of the fuel element, a plurality of optic fibres each having a first end at a first location on one of the components proximate the light source and which is not visible to a user in normal use and a second end at a given second location at or near the external surface of the fuel element between mating faces of the first and second parts, whereby light emitted from the said second ends is directly visible in normal use by a user.

Preferably the arrangement further comprises means for varying the colour and/or intensity of light from the light source before the light is incident on the optic fibres.

According to a second aspect of the invention there is provided a simulated fuel element for a simulated solid fuel fire comprising
first and second parts conjoined to define the external shape of the fuel element;
an aperture formed in one of said first and second components;
a plurality of optic fibres extending from said aperture to points at or near the external surface of the fuel element between mating faces of the first and second parts such that, when light is transmitted through said optic fibres it is directly visible by a viewer of said external surface.

The present invention also relates to a simulated solid fuel fire including a simulated solid fuel arrangement according to the first aspect of the invention or a simulated solid fuel element according to the second aspect of the invention.

For a better understanding of the invention and to show how the same may be carried into effect reference will now be made by way of example only to the following drawings in which:

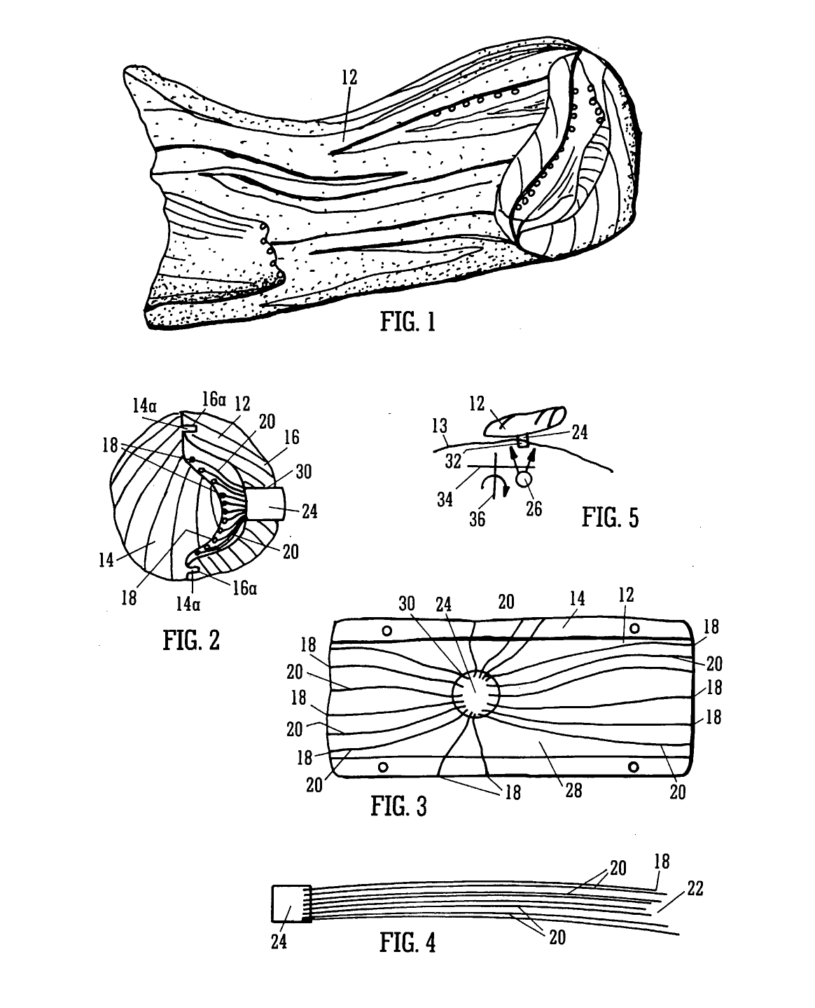

FIG. 1 is a representation of a typical simulated log for a fuel bed, according to the invention;

FIG. 2 is a cross section through a typical simulated log for a furl bed, according to the invention;

FIG. 3 is a plan view of an inner face of a half-log, according to the invention;

FIG. 4 shows a typical initial arrangement of a group of fibre optic cables for use in the invention;

FIG. 5 shows a typical arrangement of a simulated log on an ember bed, according to the invention; and

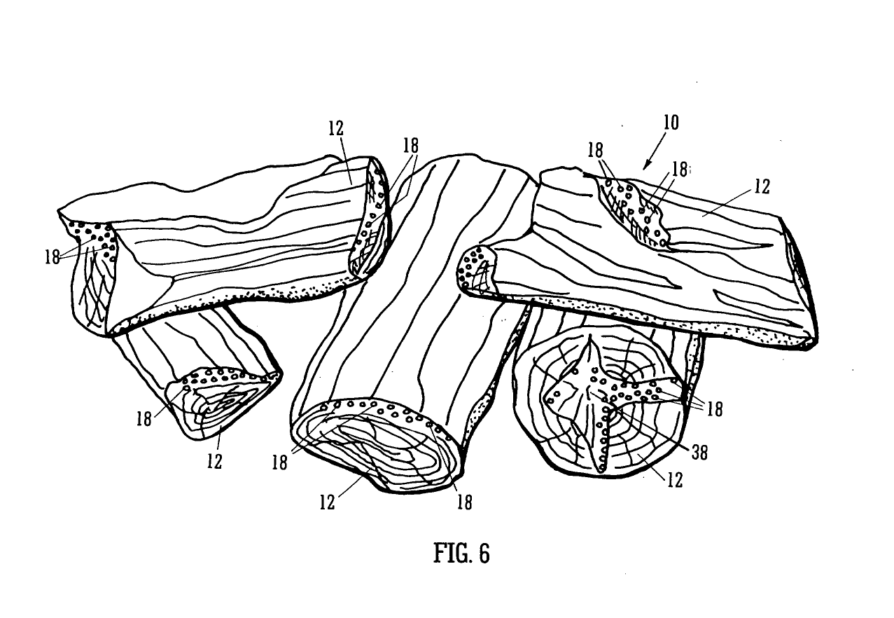

FIG. 6 shows a typical arrangement of a group of simulated logs forming a fuel bed, according to the invention.

Referring now to the drawings, the fuel bed 10 of the invention is provided with a plurality of simulated logs 12. In preferred arrangements, the logs 12 rest on an ember bed 13 which conveniently comprises a plastic moulding shaped and coloured to represent ashes and glowing embers. However, the presence of an ember bed, although desirable is not essential to the invention. The logs 12 are laid together, preferably in a predetermined arrangement to closely resemble logs of a solid fuel fire. Various materials may be used for the manufacture of the logs 12, generally as known in the art. For example, techniques are known in the art for producing mouldings from polyurethane or similar foam materials or from coloured or colourless resinous materials. The moulds are constructed to produce logs 12 of the desired shape and the resulting log shapes are painted or otherwise coloured to resemble real logs. The logs 12 may desirably at least partially translucent, or translucent in particular regions, to enhance the impression of glowing, burning logs when illuminated from below. The logs 12 of the invention are shaped to resemble a natural set of logs on a real fire. Preferably, of course, the shapes of the respectively logs are carefully determined so that they sit together securely in a predetermined arrangement which offers the most realistic impression.

The logs 12 of the invention are most preferably formed in two parts, such as an upper part and a lower part or a front part and a rear part. One part 14 of a log 12 is shown in FIG. 3 and front and rear parts 14, 16 are shown together in FIG. 2. The respective parts 14, 16 are joined together in use so that the log 12 appears to be a single entity, that is, so that the join between the respective parts is not readily apparent to a user. The parts 14, 16 may be joined together by any suitable means. In the illustrated example (FIG. 2) co-operating formation are formed on the respective parts 14, 16. Part 14 includes a number of projection 14a and part 16 includes corresponding recesses 16a which receive the projections 14a. In an alternative arrangement, the parts 14, 16 may be adhered together.

As noted above, the present invention employs fibre optics to provide an enhanced simulation of a real fire. Ends 18 of the fibre optics 20 are exposed at the surface of the assembled logs 12 so that the ends 18, and the light emitted from the ends 18 may be viewed directly by a user. The two part construction of the logs 12 enables this arrangement to be achieved. Referring more especially to FIGS. 2 to 5, the fibre optics 20 are arranged into a group or bunch 22 and are gathered together at one end 24 by any suitably permanent means, such as binding with a resin or other cureable material. As will be described in more detail below, the end 24 is arranged in use near to a light source 26. The optic fibres 20 are, of course, flexible. The fibres are arranged over an internal surface 28 of the log part 14, 16 (i.e. on a surface which is not visible when the log 12 is assembled from parts 14, 16) so that they extend to chosen points at or near the outer surface of the part 14, 16. The log 12 assembled from the parts 14, 16 may have a hollow interior and the optic fibres 20 may be disposed along any selected routeing within that interior. Thus the fibres 20 terminate at or near the outer surface of the log 12 and, during manufacture may be trimmed to the appropriate length if necessary. If necessary, the optic fibres 20 are secured in their desired locations by any suitable means such as adhesive, stapling, pining, taping and so on. On assembly of parts 14, 16 to form a log 12, the optic fibres 20 are “sandwiched” between the respective parts 14. Thus the optic fibres 20 are not themselves visible to a user, although their ends 18 are just sufficiently exposed at the junction between the parts 14, 16 to enable light emitted from them to be directly perceived by a user. The parts 14, 16 may be constructed so that the log 12 has a complex external shape including cavities and protrusions, in order to better resemble a real log. The optic fibres 20 may be arranged so that their ends are relatively isolated, or several ends 18 may be grouped together to provide local regions of greater light intensity, such as in said cavities or at said protrusions. Where the fibres 20 terminate at ends 18 within a cavity such as cavity 38 in FIG. 6 the optic fibres 20 may extend beyond the surface of the log 12 (i.e. the surface of the part 14 or 16). Bearing in mind that the log 12 is arranged in use in a specific orientation only the very ends of the fibres may nevertheless be visible to a user.

One side of one of the parts 14, 16 which is not visible to the user when the part 14, 16 is placed on the fuel bed is provided with an aperture 30 through which the fibre optics 20 pass. Conveniently, the end 24 of the bunch 22 of fibre optics 20 may be mounted in the aperture 30. As may be seen from FIG. 5, the end 24 of the optic fibre bunch 22 may also pass through a corresponding aperture 32 in an ember bed 13 (if present). The aperture 32 and the end 24 may be sized to be a friction fit with one another so that they serve to locate the assembled log 12 in its desired location on the fuel bed.

The end 24 of the bunch 22 of optic fibres 20 is arranged in juxtaposition with a light source 26. When the light source is illuminated, light is emitted from the ends 18 if the optic fibres and may be perceived by a user. Most preferably, means are provided for varying the colour and intensity of the light received by the optic fibres 20 over time. Where the light source is a simple source of white or near white light, such as a standard incandescent bulb or halogen bulb, a filter 34 may be disposed between the light source 26 and the end 24 of the optic fibres 20. In the illustrated example, the filter is a translucent disc which includes portions of different colours such as orange, yellow, red green and blue (which are typical colours which may be perceived in a real fire) which are exposed to the light source 26 in sequence. The disc is rotated about its axis 36 by suitable drive means (not shown) which may be an electric motor, for example. In an alternative arrangement, the light source 26 may be mounted within a translucent cylinder which has differently coloured portions. Rotation of the cylinder about its axis causes the differently coloured portions to pass between the light source and the end 24 of the optic fibres 20. In this way, the colour of the light falling on the end 24 of the optic fibres 20 is varied and, consequently the colour of the light emitted by the ends 18 of the optic fibres is varied. The disc 34 or cylinder may include regions which are opaque and/or which are more or less transmissive of light, so that the intensity of the light falling on the end 24 of the optic fibres 20, and emitted form ends 18, is varied.

Mechanical means may also be used for varying the intensity of the light from a light source incident on the end 24. As is well known in the art, so called “spinners” may be mounted above an incandescent light bulb. The spinners are apertured discs which rotate freely about their axis. Heat rising from the light source causes the spinner to rotate. In other arrangements a shaft having a number of approximately radial strips of material depending therefrom may be mounted between the light source 26 and the end 24, with the shaft being rotated about its axis by suitable means such as a motor.

In an alternative arrangement, the end 24 of the bunch 22 of optic fibres 20 may be disposed near an LED (light emitting diode) or a group of LEDs. So-called ultra bright LEDs are especially suitable in this respect. Where a group of LEDs is provided, the group may preferably include LEDs of different colours. The LEDs may preferably be illuminated under the control of an electronic control means to that variation in the intensity and colour of light falling on the end 24 of the optic fibres 20 is achieved.

The light source 26 need not necessarily be arranged immediately adjacent the end 24. It may be convenient, for example, to use one or more mirrors to direct light from a light source to the end 24 of the bunch 22 of optic fibres 20.

In order to provide further variation in the colour and/or intensity of the light perceived at the ends 18 of the optic fibres 20 a given log 12 may be provided with more than one bunch 22 of optic fibres 20. Each bunch 22 may be provided with its own light source 26 and light intensity and colour varying arrangement.

Although the invention has been described above in relation to a log 12 having two independent parts 14, 16 other constructions which achieve the same or a similar result are not excluded. For example, the ember bed 13 may be shaped and coloured locally to resemble a first (normally lower) part of a log, with an second (upper) part 14 or 16 then being formed independently and mounted directly on the ember bed 13 to form a log 12. In this case, the optic fibres 20 are sandwiched between the part 14 or 16 and the ember bed 13. Also, the parts 14, 16 of forming a log 12 need not be of equal size. For example, an upper part 14 of a log may form the majority of the log with a lower part 16 serving only to form an underside an end portions of the log. Also, the logs of the invention are not confined to only two parts. An upper part 14 may form the majority of a log 12, having for example an outer surface extending between points at the front and rear of the log which a user perceives as resting on the ember bed with two or more parts 16 forming only end faces of the log 12. The optic fibres 20 are still, nevertheless still generally sandwiched between the parts 14 and 16. Any region of a part 14 16 which is not visible to a user in normal use need not be shaped and coloured to resemble a log. For example, the underside of a part 16 may have a plain undecorated surface or may be shaped to conform with an underlying log or with the ember bed.

The present invention has been described in relation to solid fuel elements in the form of logs 12. However, the invention is equally applicable to simulation of other solid fuels such as coal, peat and the like.

A primary use of the logs and fuel bed according to the invention is with simulated solid fuel fires which include a heat source for space heating of a room. However, in many countries, central heating systems are used in houses, offices, hotels and other locations where a simulated fuel fire might be installed. In these locations the simulated solid fuel fire may be provided mainly for its aesthetic interest and the heat source may be dispensed with. The term “fire” in this specification should be interpreted accordingly.

1. A simulated solid fuel arrangement for a simulated solid fuel fire comprising:
a light source; and
at least one simulated solid fuel element, the solid fuel element comprising
conjoined first and second parts defining together the external shape of the fuel element, and
a plurality of optic fibres each having a first end at a first location on one of the components proximate the light source and which is not visible to a user in normal use and a second end at a given second location at or near the external surface of the fuel element between mating faces of the first and second parts,
whereby light emitted from the said second ends is directly visible in normal use by a user.

2. A simulated solid fuel arrangement as claimed in claim 1 further comprising means for varying the colour and/or intensity of light from the light source before the light is incident on the optic fibres.

3. A simulated fuel element for a simulated solid fuel fire comprising:
first and second parts conjoined to define the external shape of the fuel element;
an aperture formed in one of said first and second components; and
a plurality of optic fibres extending from said aperture to points at or near the external surface of the fuel element between mating faces of the first and second parts such that, when light is transmitted through said optic fibres it is directly visible by a viewer of said external surface.

4. A simulated solid fuel fire including a simulated solid fuel arrangement as claimed in claim 1.

5. (canceled)

6. A simulated solid fuel fire including a simulated solid fuel arrangement as claimed in claim 2.

7. A simulated solid fuel fire including a simulated solid fuel element as claimed in claim 3.
